(19) United States
(12) Patent Application Publication
(10) Pub. No.: US 2025/0170879 A1
(43) Pub. Date: May 29, 2025

(54) REAR DOOR ASSEMBLY

(71) Applicant: NISSAN NORTH AMERICA, INC., Franklin, TN (US)

(72) Inventors: David KOVIE, Livonia, MI (US); Ronald MORROW, Novi, MI (US); Christopher HERRALA, Milford, MI (US); Edward ORCSIK, LaSalle (CA); Srikanth Reddy BADDAM, Northville, MI (US)

(21) Appl. No.: 18/520,476

(22) Filed: Nov. 27, 2023

(51) Int. Cl. B60J 5/10; B60J 5/12; E05D 15/46

(52) U.S. Cl. CPC B60J 5/106; B60J 5/12; E05D 15/463

(57) ABSTRACT

A rear door assembly has a first and second support brackets and first and second arms. The first support bracket includes a vehicle attachment portion, a first support portion and a second support portion located outboard of and lower than the first support portion when installed to a vehicle. The first arm has first and second ends. The first end is pivotally attached to the first support portion. The second arm has third and fourth ends. The third end is pivotally attached to the second support portion of the first support bracket. The second support bracket has a third support portion and a fourth support portion spaced apart from one another and a rear door attachment portion. The second end of the first arm is pivotally attached to the third support portion and the fourth end of the second arm is pivotally attached to the fourth support portion.

### BACKGROUND

### Technical Field

The present disclosure generally relates to rear door assembly with a four-bar support mechanism. More specifically, the present disclosure relates to a four-bar support mechanism that moves the rear door from a closed orientation to an open orientation with rotary power provided by a motor installed within a rearward area of roof structure of a vehicle.

### Background Information

Rear doors of vehicles such as SUVs (sport utility vehicles) typically pivot rearward and upward. In a small parking space there may be insufficient room for opening a rear door while standing rearward of the rear door. Hence, there is a need for a rear door assembly that can open in a small parking space.

### SUMMARY

One object of the present disclosure is to provide a vehicle with a rear door assembly that employs a four-bar support mechanism with predetermined geometry such that the kinematics of movement of the rear door during opening and closing reduces and minimized rearward movement of the rear door and further minimizes the space necessary above the vehicle for the rear door when fully opened.

It has been discovered that providing a four-bar support mechanism of a rear door of a vehicle with fine-tuned geometry provides kinematic movement of the rear door that minimizes the space required rearward and above the vehicle. Consequently, the rear door is allowed to open and close without contacting walls and ceilings of a small space such as a small garage.

In view of the state of the known technology, one aspect of the present disclosure is to provide a rear door assembly with a first support bracket, a first arm, a second arm and a second support bracket. The first support bracket has a vehicle attachment portion, a first support portion and a second support portion located outboard of the first support portion. The first support portion is also located vertically higher than the second support portion when installed to a vehicle. The first arm has a first end and a second end. The first end is attached to the first support portion for pivotal movement about a first rotation axis defined by the first support portion. The second arm has a third end and a fourth end. The third end is attached to the second support portion of the first support bracket for pivotal movement about a second rotation axis defined by the second support portion. The first rotation axis and the second rotation axis extend in directions parallel to one another. The second support bracket has a rear door attachment portion, a third support portion and a fourth support portion spaced apart from one another. The second end of the first arm is attached to the third support portion for pivotal movement about a third rotation axis defined by the third support portion. The fourth end of the second arm is attached to the fourth support portion for pivotal movement about a fourth rotation axis.

### BRIEF DESCRIPTION OF THE DRAWINGS

Referring now to the attached drawings which form a part of this original disclosure:

FIG. 1 is a side view of a rear portion of a vehicle body structure that includes a rear door assembly with a rear door in a closed orientation in which the rear door is generally vertically oriented in accordance with a first embodiment;

FIG. 2 is another side view of the rear portion of the vehicle body structure that includes the rear door assembly with the rear door moved rearward and upward from the closed orientation to a first intermediate orientation in accordance with the first embodiment;

FIG. 3 is another side view of the rear portion of the vehicle body structure with the rear door moved further upward to a second intermediate orientation where the door has undergone angular displacement in accordance with the first embodiment;

FIG. 4 is another side view of the rear portion of the vehicle body structure with the rear door moved further upward and partially over a roof structure of the vehicle body structure to a third intermediate orientation where the door has undergone further angular displacement in accordance with the first embodiment;

FIG. 5 is another side view of the rear portion of the vehicle body structure with the rear door moved further forward over the roof structure of the vehicle body structure to a fully open orientation where the rear door has fully exposed a rear opening of the vehicle body structure in accordance with the first embodiment;

FIG. 6 is a rear view of the vehicle showing the rear door in a closed orientation in accordance with the first embodiment;

FIG. 7 is a rear view of the vehicle showing the rear door in the fully open orientation and further showing first and second hinge assemblies of a four-bar support mechanism in accordance with the first embodiment;

FIG. 8 is perspective view of the first and second hinge assemblies of the four-bar support mechanism and a locking assembly removed from the vehicle in accordance with the first embodiment;

FIG. 9 is a perspective view of a rearward corner of the vehicle body structure showing the rear door in the open orientation with the first hinge assembly installed to a recessed area and gutter area of the vehicle body structure in accordance with the first embodiment;

FIG. 10 is another perspective view of the rearward corner of the vehicle body structure looking from a different angle as compared to FIG. 9, with the rear door removed, showing details of the hinge assembly and the locking assembly in accordance with the first embodiment;

FIG. 11 an exploded perspective view of elements of the hinge assembly including a first support bracket, a second support bracket, a first arm and a second arm, an electric motor, and the locking assembly including an actuator, a lever plate, a cable, and a lever arm in accordance with the first embodiment;

FIG. 12 is a perspective view of the hinge assembly and the locking assembly removed from the vehicle, fully assembly except for the motor in accordance with the first embodiment;

FIG. 13 is another perspective view of the hinge assembly and the locking assembly removed from the vehicle, fully assembly with the motor installed to engage gear teeth within the first arm in accordance with the first embodiment;

FIG. 14 is a perspective view of a stripped down rear corner of the vehicle body structure showing the hinge assembly and the locking assembly installed thereto with the rear door removed in accordance with the first embodiment;

FIG. 15 is a perspective view of the rear corner of the vehicle body structure showing the hinge assembly and the locking assembly installed thereto showing a portion of the rear door installed to the second support bracket in accordance with the first embodiment;

FIG. 16 is a perspective view of the rear corner of the vehicle body structure showing a portion the hinge assembly installed thereto with the rear door installed to the second support bracket in accordance with the first embodiment;

FIG. 17 is a perspective view of the rear corner of the vehicle body structure from a different angle as compared to FIG. 16, showing the hinge assembly installed thereto with the rear door removed in accordance with the first embodiment;

FIG. 18 is a front view of the rear corner of the vehicle body structure with the roof structure removed to show the electric motor installed to the first end of the first arm in accordance with the first embodiment;

FIG. 19 is another perspective view of the rear portion of the vehicle body structure showing the first support bracket and the first arm in accordance with the first embodiment;

FIG. 20 is a rear view of the rear corner portion of the vehicle body structure showing the hinge assembly installed to the recessed area of the vehicle body structure and extending downward into the gutter of the vehicle body structure in accordance with the first embodiment;

FIG. 21 is a front perspective view of the rear portion of the vehicle body structure with the first arm in a position corresponding to the rear door (not shown) being in the open orientation with the first arm resting on a stop bracket of the first support bracket in accordance with the first embodiment;

FIG. 22 is another perspective view of the rear portion of the vehicle body structure showing the first support bracket, the first arm and the second arm in accordance with the first embodiment;

FIG. 23 is another perspective view similar to FIG. 22 with the first arm removed showing the shaft of the electric motor extending into the area of a first support portion of the first support bracket that otherwise would be supporting the first arm in accordance with the first embodiment;

FIG. 24 is side cross-sectional view of the rear portion of the vehicle body structure with the first arm partially cutaway showing the shaft and gear teeth of the electric motor contacting internal gear teeth within the first end of the first arm in accordance with the first embodiment;

FIG. 25 is a cross-sectional perspective view of the rear portion of the vehicle body structure showing the shaft and gear teeth of the electric motor contacting internal gear teeth within the first end of the first arm in accordance with the first embodiment;

FIG. 26 is a rear perspective view of a rearward interior portion of the vehicle body structure showing a portion of the rear door opening and the electric motor installed to an interior area of the roof structure in accordance with the first embodiment;

FIG. 27 is another rear perspective view of the rearward interior portion of the vehicle body structure similar to FIG. 26 showing interior structural panels at least partially covering the electric motor in accordance with the first embodiment;

FIG. 28 is a side view of the rearward portion of the roof structure and a side structure of the vehicle body structure showing the hinge structure and the locking mechanism with a lever arm of the locking mechanism engaged with a lock rod of the first arm with the lever arm in the locked orientation in accordance with the first embodiment;

FIG. 29 is another side view of the rearward portion of the roof structure and a side structure of the vehicle body structure similar to FIG. 28 showing the lever arm in the unlocked orientation in accordance with the first embodiment;

FIG. 30 rear view of the interior rearward portion of the roof structure of the vehicle body structure showing the electric motor of the four-bar support assembly and the actuator of the locking mechanism in accordance with the first embodiment;

FIG. 31 is a perspective view of the rearward corner of the roof structure and the vehicle body structure looking in an outboard direction showing the biasing spring, cable and the lever arm of the locking mechanism in accordance with the first embodiment;

FIG. 32 is a perspective side view of the hinge assembly of the four-bar support assembly showing a portion of the first arm and the second arm in positions corresponding to the rear door being in the closed orientation in accordance with the first embodiment;

FIG. 33 is a perspective side view of the hinge assembly of the four-bar support assembly showing the first arm and the second arm in positions corresponding to the rear door being in the fully open orientation in accordance with the first embodiment; and

FIG. 34 an exploded perspective view of elements of a hinge assembly including an inboard support bracket, an outboard support bracket, a second support bracket, a first arm and a second arm, an electric motor, and the locking assembly including an actuator, a lever plate, a cable, and a lever arm in accordance with a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

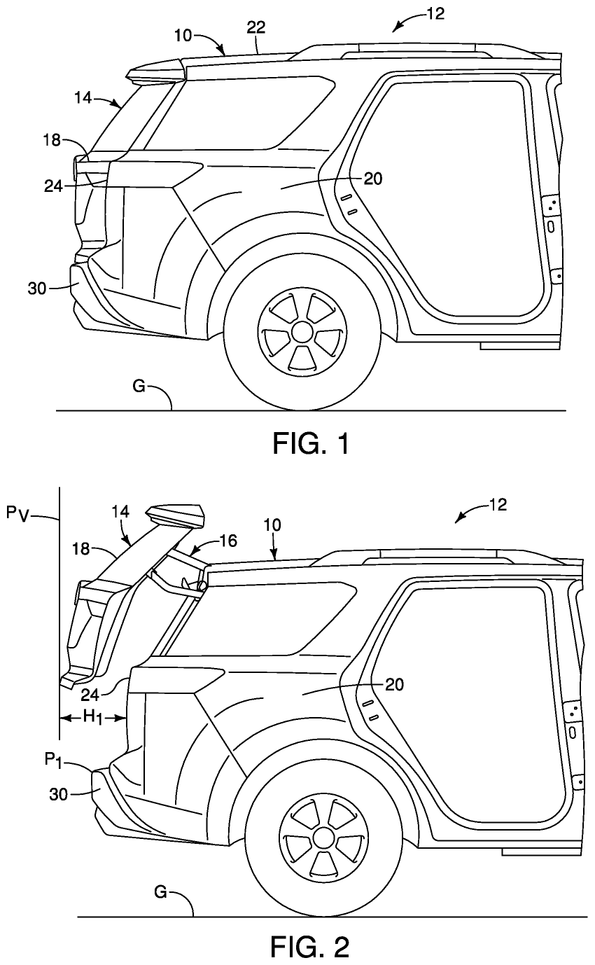

Referring initially to FIG. 1, a vehicle body structure 10 of a vehicle 12 having a rear door assembly 14 is illustrated in accordance with a first embodiment.

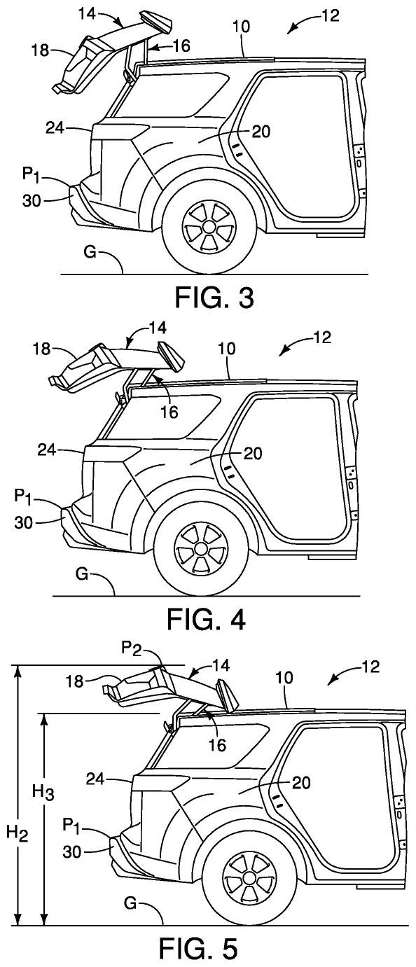

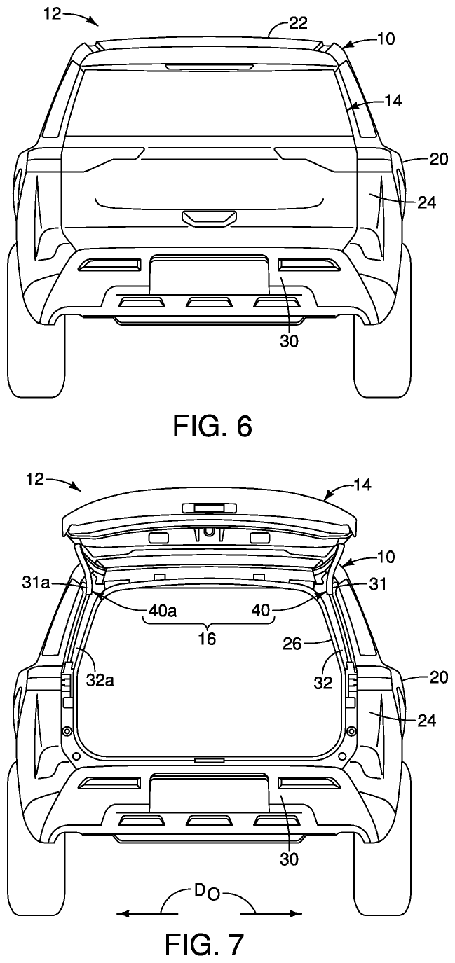

The rear door assembly 14 includes a four-bar support mechanism 16 that supports a rear door 18 and is described in greater detail below. The four-bar support mechanism 16 is kinematically dimensioned and configured to move the rear door 18 of the vehicle 12 from a closed orientation shown in FIGS. 1 and 6 to various intermediate orientations shown in FIGS. 2-4 and eventually to a fully open orientation shown in FIGS. 5 and 7.

The vehicle body structure 10 includes, among other features side structures 20, a roof structure 22 and a rear structure 24 that are all rigidly connected to one another by, for example, various welding techniques. The rear structure 24 defines a rear door opening 26. When the rear door 18 is in the closed orientation, the rear door 18 covers the rear door opening 16. When the rear door 18 is in the open orientation, the rear door opening 16 is fully exposed, as shown in FIG. 7.

As is described in greater detail below, the rear door assembly 14, and in particular, the four bar-support mechanism 16 of the rear door assembly 14, is configured such that the rear door 18 remains very close to the rear structure 24 and the roof structure 22 of the vehicle body structure 10 during movement of the rear door 18 between the closed orientation and the open orientation.

Specifically, when the rear door 18 is in the first intermediate orientation shown in FIG. 2, a lower end 18a of the rear door 18 moves a distance H₁ away from the rear structure 24 with little or no further rearward displacement as the rear door 18 moves upward to the open orientation. More specifically, during the opening movement of the rear door 18, more than three quarters of the entire rear door 18 is located above and forward of a rearmost point P₁ from the fascia of a bumper assembly 33 relative to a vertical plane P_{V}, as shown in FIG. 2. In other words, only a very small percentage of the rear door 18 displaced rearward of the bumper assembly 33. This means that a person can be standing only a short distance away from the rear structure 24 of the vehicle 12 during opening and closing of the rear door 18.

The rear structure 24 further includes recessed areas 31 and 31a, as shown in FIG. 7. The recessed areas 31 and 31a are located on opposite sides of the rear structure 24 above and at least partially outboard of the rear door opening 26. Below each of the recessed areas 31 and 31a are gutters 32 and 32a that extend downward from respective ones of the recessed areas 31 and 31a alongside corresponding sides of the rear door opening 26.

Further, when the rear door 18 is in the fully open orientation, as shown in FIG. 5, a topmost part P₂ of the rear door 18 is at a height H₂ above ground level G. The roof structure 20 of the vehicle body structure 10 is located at a height H₃ above ground level G. The height H₃ is approximately 81% of the height H₂. In other words, the topmost part P₂ of the rear door 18 (at height H₂) is located less than 20% above the height of the roof structure 22 (the height H₃). This means that the rear door 18 can be opened in most typical garages where the ceiling height of the garage is greater than the height H₂.

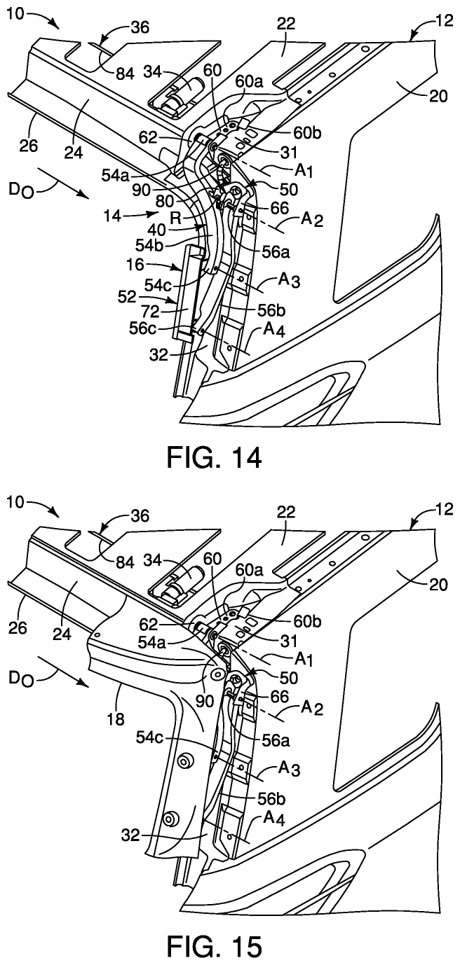

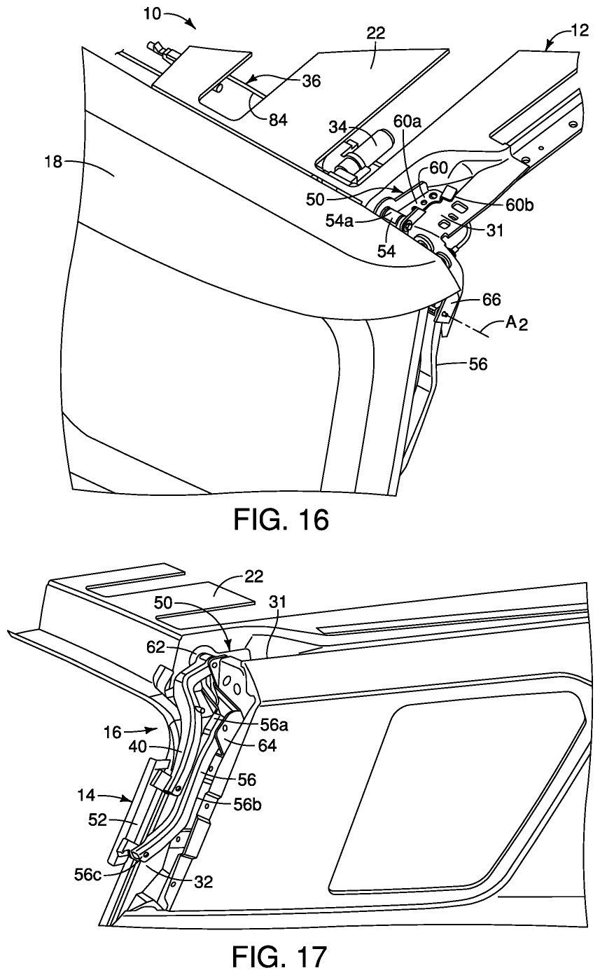

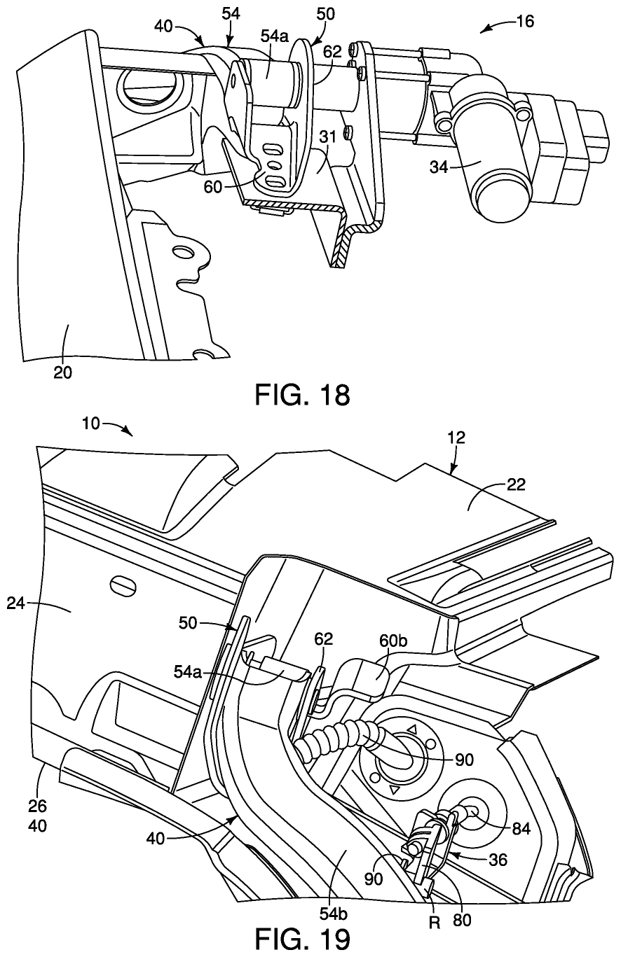

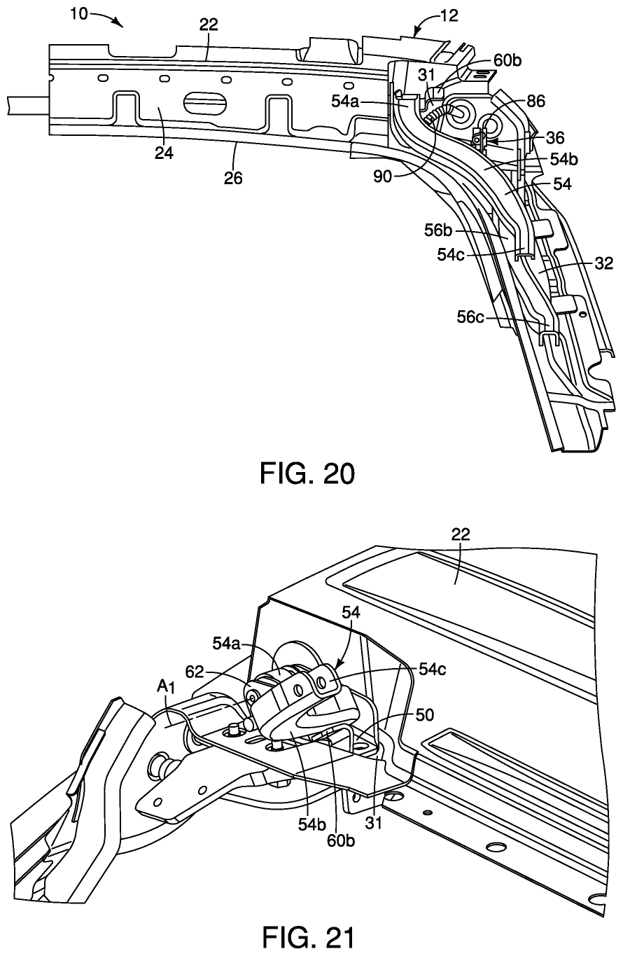

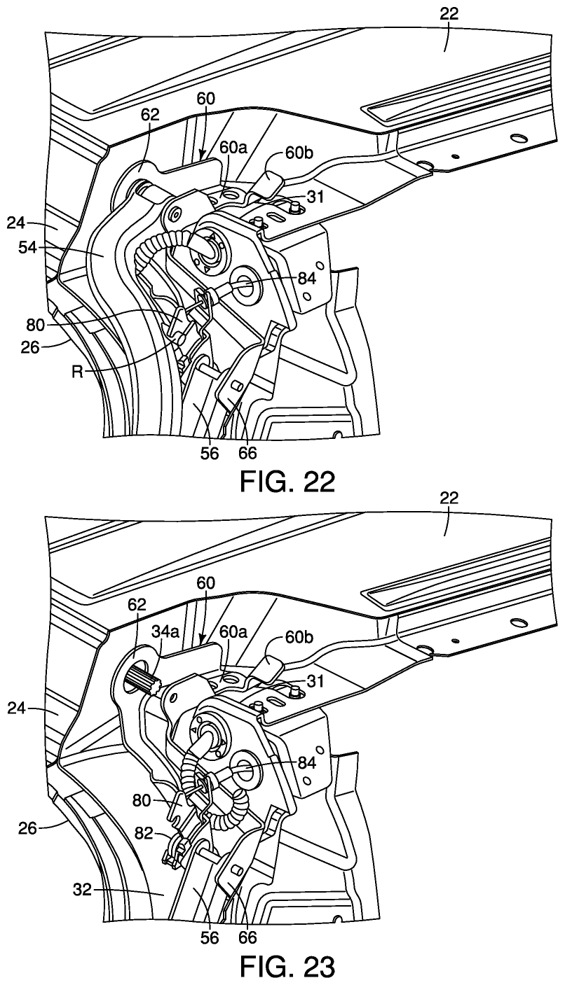

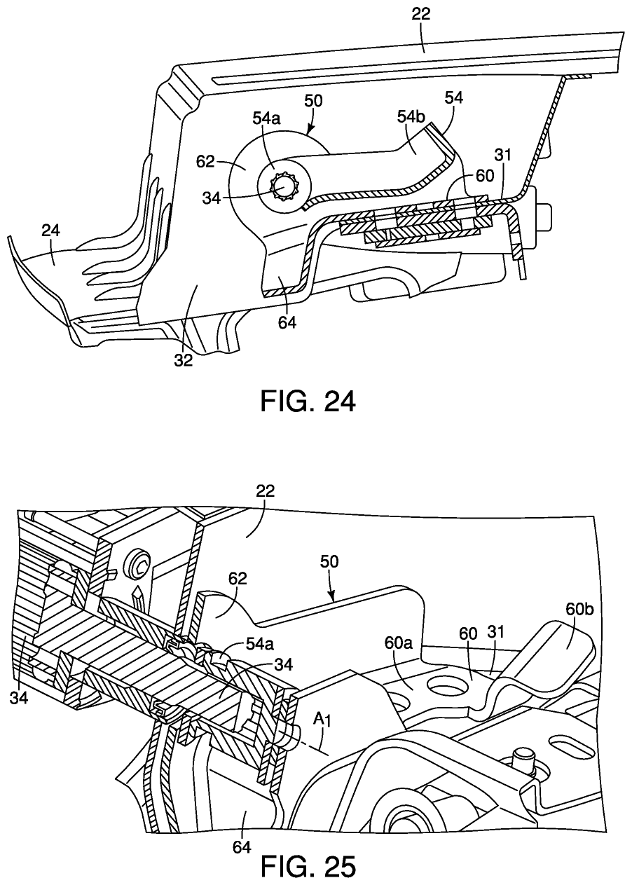

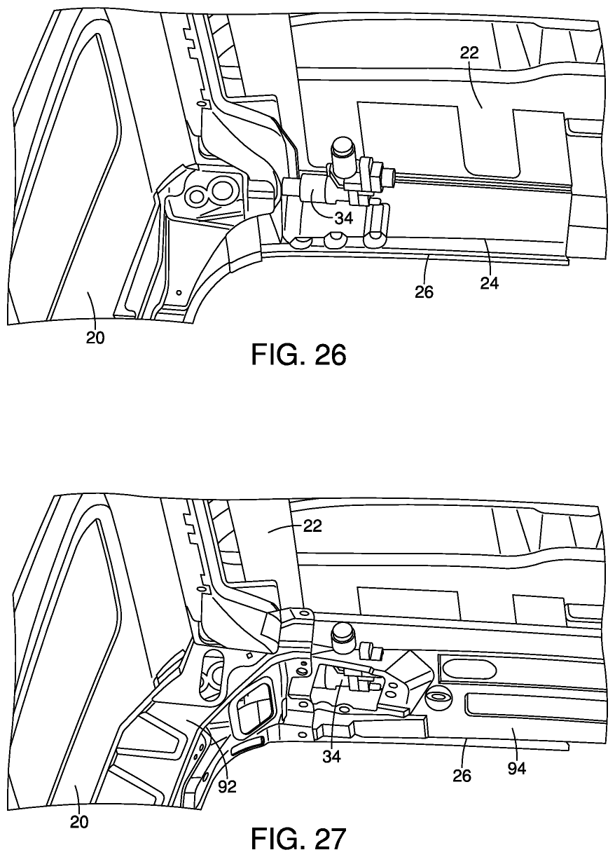

A description of the rear door assembly 14 and the four-bar support mechanism 16 is now provided with specific reference to FIGS. 7-27. The rear door assembly 14 includes the four-bar support mechanism 16, an electric motor 34 and a locking assembly 36.

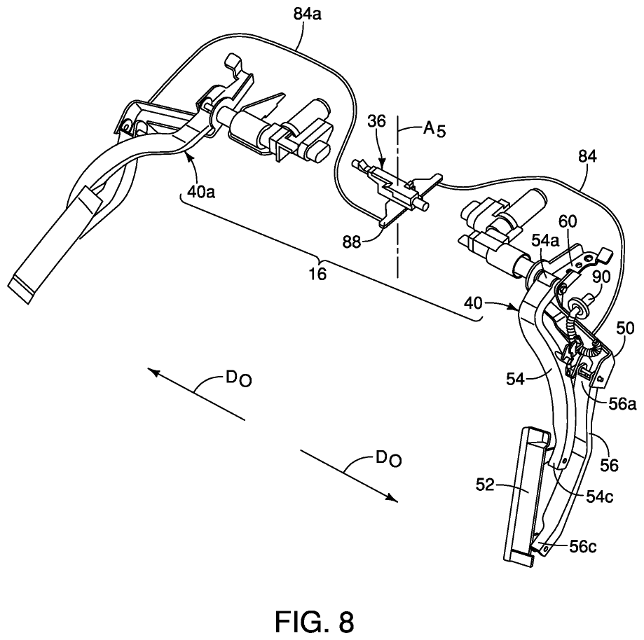

As shown in FIGS. 7-13, the four-bar support mechanism 16 includes two hinge assemblies 40 and 40a, as shown in FIGS. 7 and 8. The hinge assemblies 40 and 40a are basically identical to one another, except that they are symmetrical mirror images of one another. Therefore, in the description below, although the hinge assembly 40a will occasionally be referenced, the description below will focus on the hinge assembly 40, for the sake of brevity. It should be understood from the drawings and the description herein, that description of the hinge assembly 40 applies equally to the hinge assembly 40a.

Each of the hinge assemblies 40 and 40a have two pivoting bars, as described below. Hence, since there are four pivoting bars total in the hinge assemblies 40 and 40a, the two hinge assemblies 40 and 40a together, and associated elements, define the four-bar support mechanism 16 described below.

As shown in FIG. 8, with the four-bar support mechanism 16 removed from the vehicle body structure 10, the four-bar support mechanism 16 is a stand alone assembly that can be installed to any vehicle that includes a rear door such as the rear door 18 and a rear door opening such as the rear door opening 26.

As shown in FIG. 8, the hinge assembly 40 (also referred to as a support structure 40) has a first support bracket 50 and a second support bracket 52, a first arm 54 and a second arm 56.

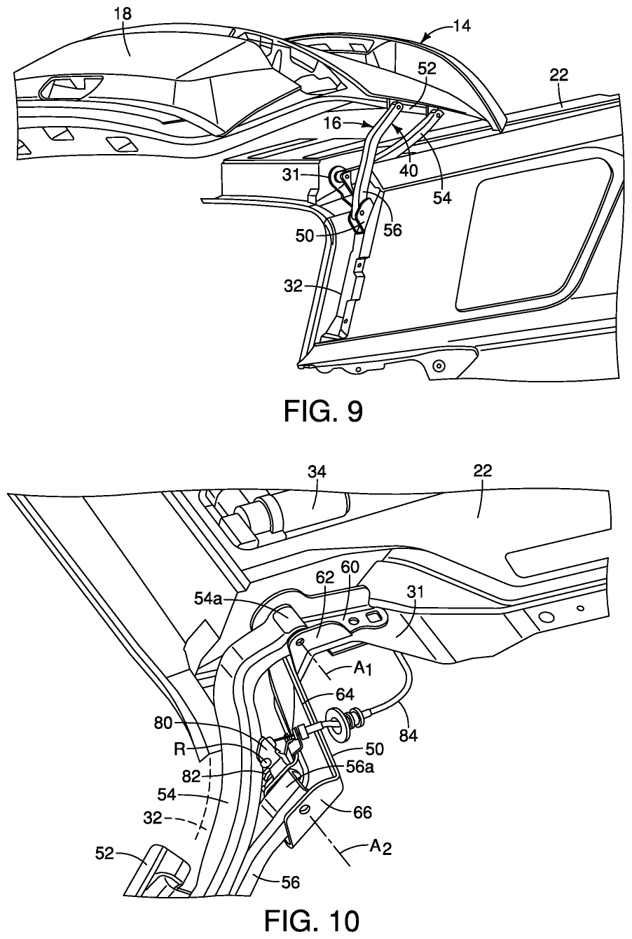

As shown in FIGS. 9-10, 14-17 and 19, the first support bracket 50 is installed to the recessed area 31 and extends laterally in an outboard direction and downward into an upper area of the gutter 32 via mechanical fasteners. A conduit 90 is shown in FIG. 19 extending out of an opening in the roof structure 22. The conduit 90 can be employed to protect a wiring harness (not shown) that extends through the conduit 90 and into a hollow portion of the first arm 54 and further into the rear door 18.

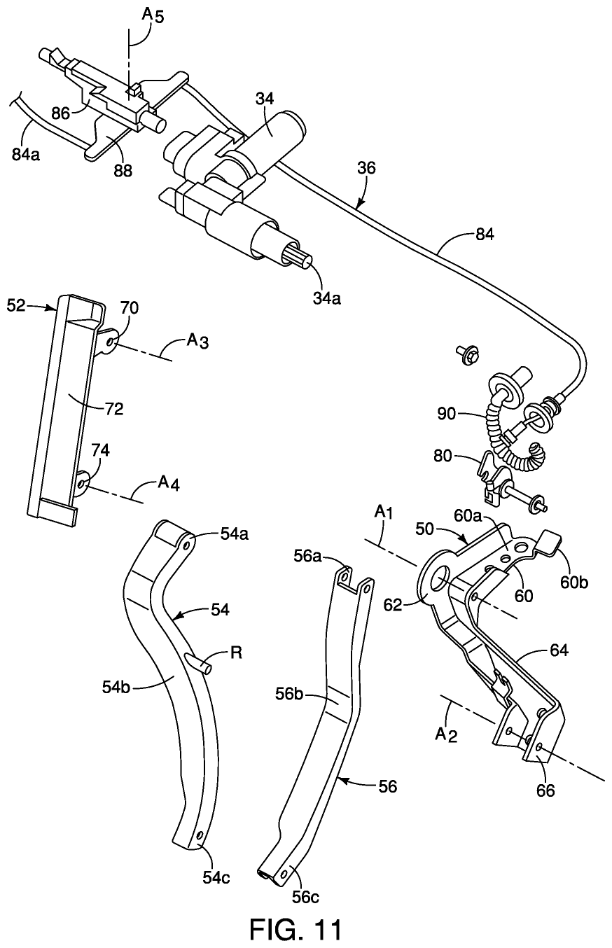

As shown in FIG. 11, the first support bracket 50 has a vehicle attachment portion 60, a first support portion 62, an intermediate section 64, and a second support portion 66 located outboard of the first support portion 62. The first support portion 60 is also located vertically higher than the second support portion 66 when installed to a vehicle 12. The vehicle attachment portion 60 of the first support bracket 50 includes a generally horizontally oriented section 60a and a stop bracket 60b. The generally horizontally oriented section 60a includes openings for mechanical fasteners that thread into corresponding threaded openings in the recessed area 31 for fixedly attaching the first support bracket 50 to the recessed area 31.

The intermediate section 64 of the first support bracket 50 extends in a vehicle outboard direction D_{O} from the generally horizontally oriented section 60a of the vehicle attachment portion 60.

The first support portion 62 is located at a rearward end of the generally horizontally oriented section 60a. The first support portion 62 includes two parallel flanges with openings whose centers define a first rotation axis A₁. The second support portion 66 extends downward from an outboard end of the intermediate section 64. The second support portion 66 includes two parallel flanges with openings whose centers define a second rotation axis A₂. The first rotation axis A₁ and the second rotation axis A₂ extend in directions that are parallel to one another. The first support bracket 50 is fixedly attached to the vehicle body structure 10 within the recessed area 31. The recessed area 31 is located adjacent to an upper end of the rear door opening 26. Specifically, the horizontally oriented section 60a of the first support bracket 60 is attached to the recessed area 31 by mechanical fasteners (not shown). The second support portion 66 of the first support bracket 50 is attached to the gutter 32 via mechanical fasteners (not shown).

The second support bracket 52 has a third support portion 70, a rear door attachment portion 72 and a fourth support portion 74. The third support portion 70 and the fourth support portion 74 are spaced apart from one another with the rear door attachment portion 72 extending therebetween. The third support portion 70 includes at least one flange with an opening that defines a third rotation axis A₃. The fourth support portion 74 includes at least one flange with an opening that defines a fourth rotation axis A₄. The third rotation axis A₃ and the fourth rotation axis A₄ extend in directions that are parallel to one another. Further, the first rotation axis A₁, the second rotation axis A₂, the third rotation axis A₃ and the fourth rotation axis A₄ all extend in directions that are parallel to one another.

The first arm 54 has a first end 54a, an intermediate section 54b and a second end 54c. The intermediate section is located between the first end 54a and the second end 54c of the first arm 54. The intermediate section 54b curves in an outboard direction from the first end 54a and downward to the second end 54c of the first arm 54 with the rear door 18 in the closed orientation. In other words, the first arm 54 is not straight but curves in an outboard direction. The intermediate section 54b includes a lock engagement structure R (hereinafter referred to as a rod R or lock rod R). The rod R is preferably a cylindrically shaped rod that is welded or otherwise rigidly fixed to the first arm 54 and extends in an outboard direction from the first arm 54 in a manner described further below.

The first end 54a is attached to the first support portion 62 of the first support bracket 50 for pivotal movement about the first rotation axis A₁ defined by the first support portion 62 of the first support bracket 50. The second end 54c is attached to the third support portion 70 of the second support bracket 52 for pivotal movement about the third rotation axis A₃ defined by the third support portion 70 of the second support bracket 52.

The second arm 56 has a third end 56a, an intermediate section 56b and a fourth end 56c. The third end 56a is attached to the second support portion 66 of the first support bracket 50 for pivotal movement about a second rotation axis A₂ defined by the second support portion 66. The first rotation axis A₁ and the second rotation axis A₂ extend in directions parallel to one another. The second arm 56 has an intermediate section 56b between the third end 56a and the fourth end 56c of the second arm. The intermediate section extends downward from the third end 56a of the second arm 56. The intermediate section 56b further has a curved section that extends in a rearward direction to the second end 56c of the second arm 56 with the rear door 18 in the closed orientation.

The second end 54c of the first arm 54 is attached to the third support portion 70 of the second support bracket 52 for pivotal movement about a third rotation axis A₃ defined by the third support portion 70. The fourth end 56c of the second arm 56 is attached to the fourth support portion 74 for pivotal movement about a fourth rotation axis A₄.

The rear door attachment portion 72 of the second support bracket 52 includes a flat section that extends between the third support portion 70 and the fourth support portion 72 of the second support bracket 52. The rear door attachment portion 72 is attached to the lateral side of the rear door 18 via mechanical fasteners (not shown).

The stop bracket 60b of the first support bracket 50 is positioned and oriented to stop or limit movement the first arm 54 once the rear door 18 has moved toward the open orientation. Further, the stop bracket 60b further provides a place for the first arm 54 (and the rear door 18) to rest when the rear door 18 is in the open orientation.

As shown in FIGS. 8, 10-16, 18 and 23-27, the electric motor 34 is installed to a side rear area of the roof structure 22 such that a shaft 34a of the motor extends through an opening in the roof structure into the recessed area 31 and into a gear fixed within the first end 54a of the first arm 54 of the four-bar support mechanism 16. Specifically, see the cross-section in FIG. 25.

The rotary shaft 34a of the electric motor 34 has outer splines or gear teeth that define a gear fixed to the rotary shaft 34a. The gear of the rotary shaft 34a is inserted into the first end 54a of the first arm 54. The first end 54a has inner gear teeth defining a gear that meshed with and therefore rotates with the moto 34. Operation of the motor 34 moves or pivots the first arm 54 about the first rotation axis A₁ and further causing corresponding pivoting motion of the second arm 56 and the second support bracket 52 due to the pivoting configuration of the ends of the second arm 54 about the pivot axes A₂ and A₄.

More specifically, rotation of the shaft 34a of the motor 34 causes pivotal movement of the arms 54 and 56 which in turn causes movement of the rear door 18 between the closed orientation and the closed orientation.

When the operation of the motor 34 pivots the rear door 18 to the open orientation, the rear door opening 26 is fully exposed. When the operation of the motor 34 pivots the rear door 18 to the closed orientation, the rear door opening 26 is fully covered. In the closed orientation the rear door 18 is in a vertical orientation and in the open orientation the rear door 18 is in a horizontal orientation with at least half of the rear door 18 being located above the roof structure 24 of the vehicle body structure 10.

The four-bar support mechanism 16 is configured such that the first support portion 62 is located inboard of the second support portion 66 of the first support bracket 50. Put another way, the second support portion 66 of the first support bracket 50 is located outboard of the first support portion 62 of the first support bracket 50. Further, the first support portion 62 is located vertically higher than the second support portion 66 of the first support bracket 50 when installed to the vehicle body structure 10.

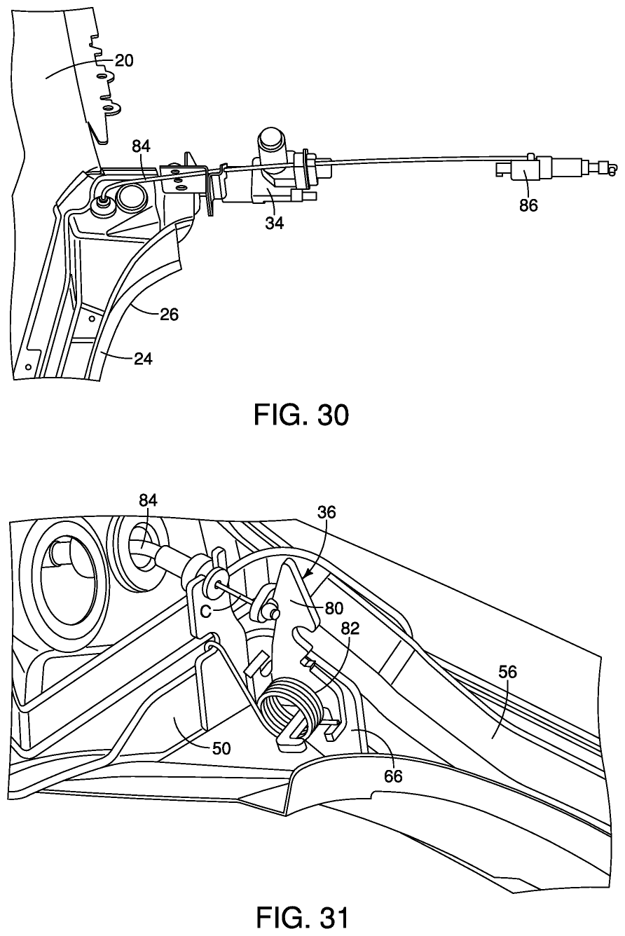

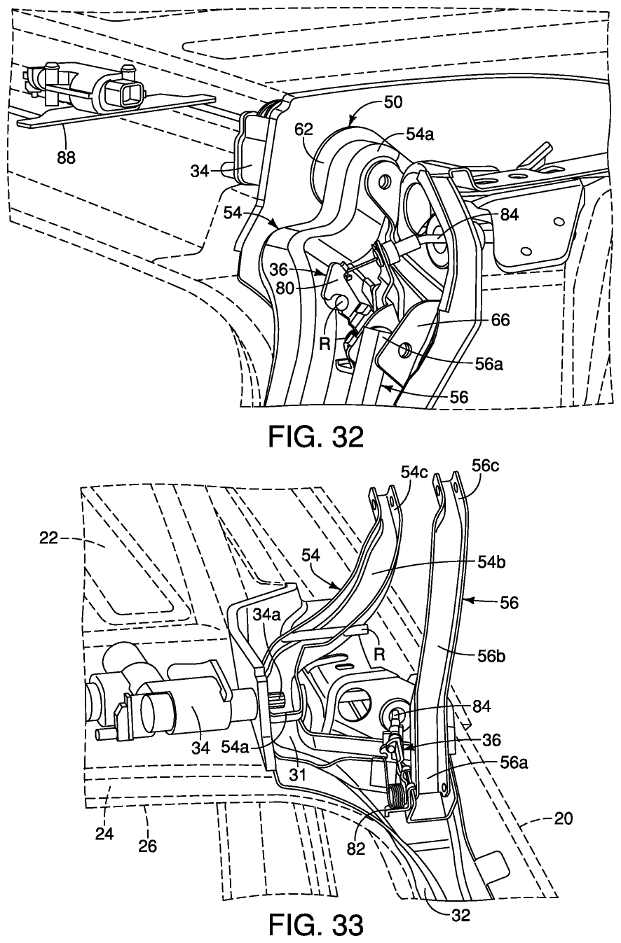

As shown in FIGS. 8, 10-13, 19-20, 22-23 and 28-34, the locking assembly 36 (also referred to as the rear door lock assembly 36) includes a locking member 80 (also referred to as a lever arm 80), a biasing spring 82, cable 84 (and 84a), inner cable C, actuator 86, lever plate 88 and a lock rod R.

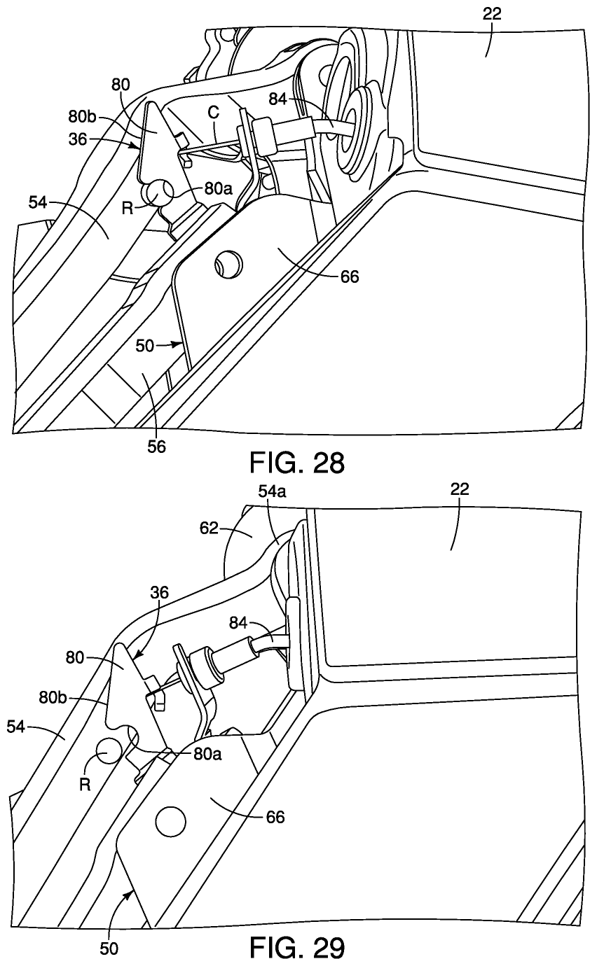

As shown in FIGS. 28 and 29, the locking member 80 (the lever arm 80) is attached to the second support portion 66 for pivotal movement with respect thereto. For example, the lever arm 80 can be supported on a shaft aligned with the second rotation axis A₂. The lever arm 80 is specifically dimensioned and shaped to engage and disengage the lock rod R. Put another way, the lever arm 80 is movable between a locked orientation (FIG. 28) and an unlocked orientation (FIG. 29). As shown in FIG. 28, the lock arm 80 is engaged with the lock rod R thereby preventing movement of the first arm 54 and all elements of the four-bar support mechanism 16. More specifically, when the lock arm 80 is engaged with the lock rod R as shown in FIG. 28 (the locked orientation), the rear door 18 is locked in the closed orientation and cannot be opened.

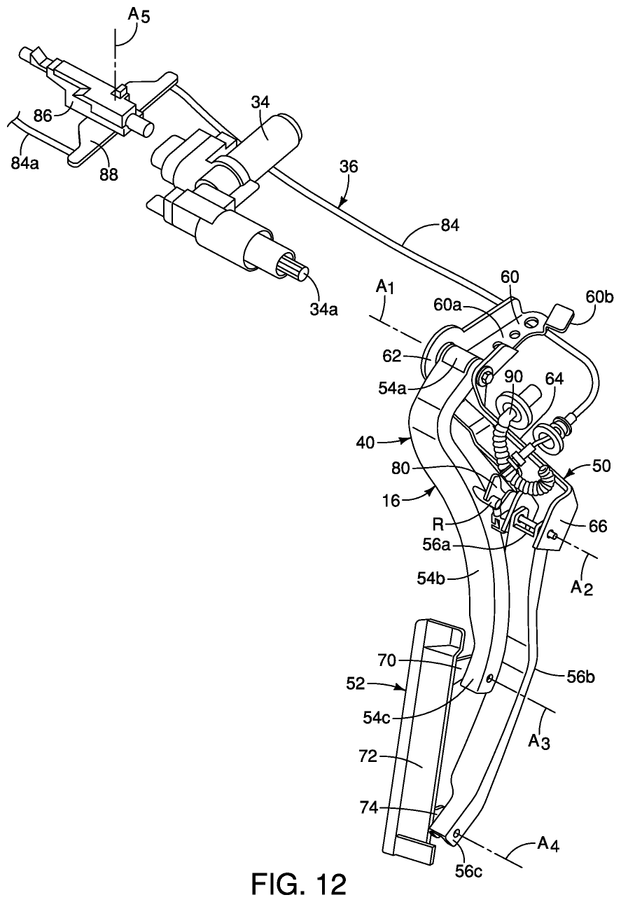

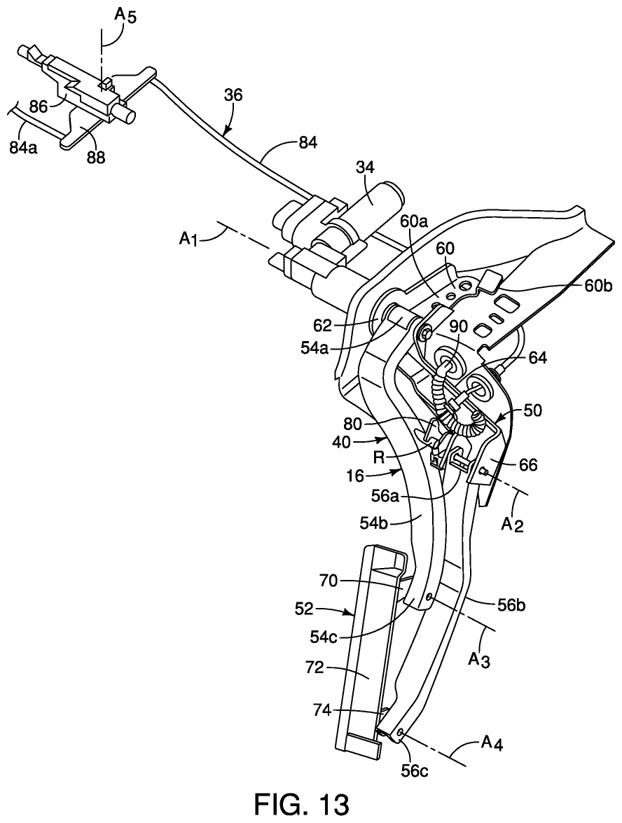

As shown in FIG. 29, when the lock arm 80 is dis-engaged from the lock rod R (the unlocked orientation), the first arm 54 and all elements of the four-bar support mechanism 16 are free to move the rear door 18 from the closed orientation to the open orientation. As shown in FIGS. 12 and 13, the rod R extends in an outboard direction such that the lock arm 80 can engage and dis-engage from the rod R, as described below.

The lock arm 80 is attached to the inner cable C which is free to move in a lengthwise direction within the housing of the cable 84. The cable 84 can be, for example, a Bowden cable where a flexible hollow outer cable housing of the cable 84 allows linear movement of the inner cable C, with the inner cable C being capable of applying compressive and tensile forces thereby moving the lock arm 80. Since Bowden cables are conventional mechanical constructs, further description is omitted for the sake of brevity.

The lock arm 80 includes a recessed area 80a that is shaped to receive the lock rod R. Above the recessed area 80a is a tapered surface 80b that is contacted by the lock rod R when the rear door 18 is in the process of moving into the closed orientation. During such movement, the lock rod R contacts the tapered surface 80b pushing the lock arm 80 against the force of the biasing spring 82 (shown in FIG. 31) toward the unlocked orientation. The tapered surface 80b is basically a cam surface that responds to movement of the lock rod R as it contacts the cam surface.

Once the lock rod R is located within the recessed area 80a, the force of the biasing spring 82 urges the lock arm 80 into the locked orientation.

The locking member 80 is movable between a locked orientation and an unlocked orientation such that in the locked orientation the locking member 80 engages the lock rod R (the lock engagement structure R) of the first arm 54 of the four-bar support mechanism 16 preventing movement of the rear door 18 from the closed orientation and in the unlocked orientation the locking member 80 is moved away from the lock engagement structure R releasing the rear door 18.

It should be understood from the drawings and the description herein that a second locking mechanism is located on the four-bar support mechanism 16 (the hinge assembly 40a in FIG. 8) at the opposite side of the vehicle body structure 10. The second locking mechanism also includes a lever arm that is controlled by a second cable 84a shown in FIG. 13.

The actuator 86 is preferably an electric motor or solenoid mechanism that is operated to rotate the lever plate 88 about the fifth axis A₅. The actuator 86 is fixed to a panel or panels (not shown) within the rearward portion of the roof structure 22. The actuator 86 includes a rotatable shaft (not shown) that defines a fifth axis of rotation A₅, as shown in FIGS. 12 and 13. The shaft of the actuator 86 is fixed to a lever plate 88 that pivots about the fifth axis of rotation A₅ when the actuator 86 is operated.

It should be understood from the drawings and the description herein that the two parts of a conventional locking mechanism can be installed to the bottom of the rear door 18 and at the center of the bottom of the rear door opening (above the bumper assembly 33), as shown in FIG. 7.

The actuator 86 and the electric motor 34 can be connected to an electronic controller (not shown) that is programmed to operate each of the actuator 86 and the electric motor 34 for the purpose of locking and unlocking the rear door 18 and opening and closing the rear door 18 upon receiving commands to do so from either a vehicle operator or a vehicle passenger.

The electronic controller preferably includes a microcomputer with a control program that controls the actuator 86 and the electric motor 34. The controller can also include other conventional components such as an input interface circuit, an output interface circuit, and storage devices such as a ROM (Read Only Memory) device and a RAM (Random Access Memory) device. The microcomputer of the controller is programmed to control the actuator 86 and the electric motor 34. The memory circuit stores processing results and control programs such as ones for operations that are run by the processor circuit. The controller is operatively coupled to the actuator 86 and the electric motor 34 in a conventional manner. The controller is further connected to a switch or switches that can be operated by a vehicle operator or a vehicle passenger in order to lock and unlock, and, open or close the rear door 18.

### Second Embodiment

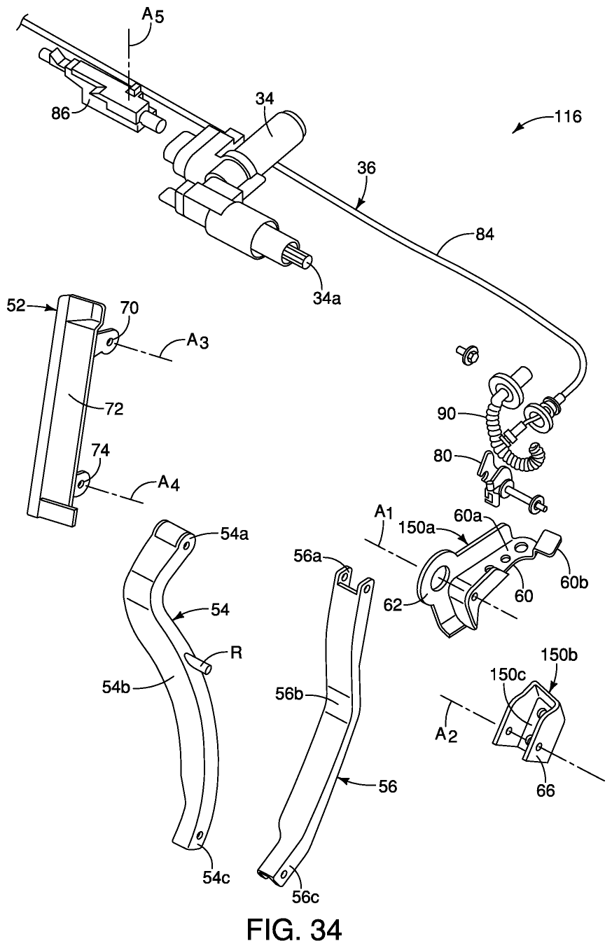

Referring now to FIG. 34, a four-bar support mechanism 116 having first support brackets 150a and 150b in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

In the second embodiment, the four-bar support mechanism 116 includes the second supporting bracket 52, the first arm 54 and the second arm 56 as described above with respect to the first embodiment. However, in the second embodiment the first support bracket 50 has been replaced with a bracket 150a and a bracket 150b.

The bracket 150a includes the vehicle attachment portion 60 and the first support portion 62 as described above in the first embodiment. The bracket 150b includes the second support portion 66 as described above in the first embodiment. However, the intermediate section 64 of the first support bracket 50 of the first embodiment has been eliminated.

The various structures of the vehicle body structure 10 (other than the four-bar support mechanism 16 and 116) are conventional components that are well known in the art. Since these structures are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the rear door assembly. Accordingly, these terms, as utilized to describe the present invention should be interpreted relative to a vehicle equipped with the rear door assembly.

The term “configured” as used herein to describe a component, section or part of a device that includes structure, hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A rear door assembly comprising:
a first support bracket having a vehicle attachment portion, a first support portion and a second support portion located outboard of the first support portion, the first support portion also being located vertically higher than the second support portion when installed to a vehicle;
a first arm having a first end and a second end, the first end being attached to the first support portion for pivotal movement about a first rotation axis defined by the first support portion;
a second arm having a third end and a fourth end, the third end being attached to the second support portion of the first support bracket for pivotal movement about a second rotation axis defined by the second support portion, the first rotation axis and the second rotation axis extending in directions parallel to one another; and
a second support bracket having a rear door attachment portion, a third support portion and a fourth support portion spaced apart from one another, the second end of the first arm being attached to the third support portion for pivotal movement about a third rotation axis defined by the third support portion and the fourth end of the second arm being attached to the fourth support portion for pivotal movement about a fourth rotation axis.

2. The rear door assembly according to claim 1, wherein
the vehicle attachment portion of the first support bracket includes a generally horizontally oriented section.

3. The rear door assembly according to claim 2, wherein
the first support bracket includes an intermediate section that extends in a vehicle outboard direction from the generally horizontally oriented section of the vehicle attachment portion.

4. The rear door assembly according to claim 3, wherein
the first support portion is located at a rearward end of the generally horizontally oriented section and the second support portion extends downward from an outboard end of the intermediate section.

5. The rear door assembly according to claim 1, further comprising
an electric motor with a rotary shaft and a gear fixed to the rotary shaft, the gear and a portion of the rotary shaft being inserted into a gear fixedly attached to the first end of the first arm such that operation of the motor pivots the first arm about the first rotation axis and further causing corresponding pivoting motion of the second arm and the second support bracket.

6. The rear door assembly according to claim 1, further comprising
a vehicle body structure of a vehicle, the vehicle body structure defining a rear door opening, the first support bracket being rigidly installed to an upper area of a first side of the vehicle body structure adjacent to an upper corner area of the rear door opening; and
a rear door attached to the rear door attachment portion of the second support bracket such that operation of the motor further pivots the rear door between a closed orientation covering the rear door opening and an open orientation fully exposing the rear door opening, such that in the closed orientation the rear door is in a vertical orientation and in the open orientation the rear door is in a horizontal orientation with at least half of the rear door being located above a roof portion of the vehicle body structure.

7. The rear door assembly according to claim 6, further comprising
an electric motor with a rotary shaft and a gear fixed to the rotary shaft, the gear and a portion of the rotary shaft being inserted into a gear fixedly attached to the first end of the first arm such that operation of the motor pivots the first arm about the first rotation axis and further causing corresponding pivoting motion of the second arm and the second support bracket.

8. The rear door assembly according to claim 6, wherein
the first arm has an intermediate section located between the first end and the second end of the first arm, the intermediate section curving in an outboard direction from the first end and downward to the second end of the first arm with the rear door in the closed orientation.

9. The rear door assembly according to claim 6, wherein
the second arm has an intermediate section between the first end and the second end of the second arm, the intermediate section extending downward from the first end of the second arm, the intermediate section further having a curved section that extends in a rearward direction to the second end of the second arm with the rear door in the closed orientation.

10. The rear door assembly according to claim 6, wherein
the rear door attachment portion of the second support bracket includes a flat section that extends between the third support portion and the fourth support portion of the second support bracket.

11. A rear door assembly comprising:
a vehicle body structure defining a rear door opening;
a rear door dimensioned and shaped for movement between a closed orientation covering the rear door opening and an open orientation exposing the rear door opening;
a support structure having a first support bracket and a second support bracket with two arms each being attached at opposite ends thereof to the first support bracket and the second support bracket for pivotal movement with respect thereto, the first support bracket being fixedly attached to the vehicle body structure adjacent to an upper end of the rear door opening, the second support bracket being attached to the rear door; and
a motor fixed to the vehicle body structure above one side of the rear door opening, the motor having a shaft that extends into and directly engages an adjacent one of the arms such that rotation of the motor causes pivotal movement of the arm which in turn causes movement of the rear door between the closed orientation and the closed orientation.

12. The rear door assembly according to claim 11, wherein
the first support bracket has a vehicle attachment portion attached to the vehicle body structure, a first support portion and a second support portion located outboard of the first support portion, the first support portion also being located vertically higher than the second support portion when installed to the vehicle body structure.

13. The rear door assembly according to claim 12, wherein
the two arms include a first arm having a first end and a second end, the first end being attached to the first support portion for pivotal movement about a first rotation axis defined by the first support portion, and a second arm having a third end and a fourth end, the third end being attached to the second support portion of the first support bracket for pivotal movement about a second rotation axis defined by the second support portion, the first rotation axis and the second rotation axis extending in directions parallel to one another.

14. The rear door assembly according to claim 13, wherein
the support structure further includes a second support bracket having a rear door attachment portion, a third support portion and a fourth support portion spaced apart from one another, the second end of the first arm being attached to the third support portion for pivotal movement about a third rotation axis defined by the third support portion and the fourth end of the second arm being attached to the fourth support portion for pivotal movement about a fourth rotation axis.

15. The rear door assembly according to claim 14, wherein
the first support bracket includes an intermediate section that extends in a vehicle outboard direction from a generally horizontally oriented section of the vehicle attachment portion, and the first support portion of the first support bracket is located at a rearward end of the generally horizontally oriented section and the second support portion extends downward from an outboard end of the intermediate section.

16. The rear door assembly according to claim 13, wherein
the first arm has an intermediate section located between the first end and the second end of the first arm, the intermediate section curving in an outboard direction from the first end and downward to the second end of the first arm with the rear door in the closed orientation.

17. The rear door assembly according to claim 13, wherein
the second arm has an intermediate section between the first end and the second end of the second arm, the intermediate section extending downward from the first end of the second arm, the intermediate section further having a curved section that extends in a rearward direction to the second end of the second arm with the rear door in the closed orientation.
